(19) United States
(12) Patent Application Publication
(10) Pub. No.: US 2010/0208965 A1
(43) Pub. Date: Aug. 19, 2010

(54) Method and Apparatus for Tomographic Imaging of Absolute Optical Absorption Coefficient in Turbid Media Using Combined Photoacoustic and Diffusing Light Measurements

(75) Inventors: Huabei Jiang, Gainesville, FL (US); Zhen Yuan, Gainesville, FL (US); Qiang Wang, Gainesville, FL (US); Lu Yin, Gainesville, FL (US); Qizhi Zhang, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: University of Florida Research Foundation, Inc., Gainesville, FL (US)

(21) Appl. No.: 12/668,976

(22) PCT Filed: Mar. 5, 2008
(86) PCT No.: PCT/US08/55894

§ 371 Date: Jan. 13, 2010

Related U.S. Application Data
(60) Provisional application No. 60/950,304, filed on Jul. 17, 2007.

(51) Int. Cl. G06K 9/00

(52) U.S. Cl. 382/131

(57) ABSTRACT

Embodiments of the invention pertain to methods for imaging a light absorption coefficient distribution. Embodiments of the subject method can be implemented without knowing the strength of incident light in advance and without requiring careful calibrations in the non-scattering medium. Embodiments of the method can combine conventional photoacoustic tomography (PAT) with diffusing light measurements coupled with an optimization procedure based on the photon diffusion equation. Images of absorbing targets as small as 0.5 mm in diameter embedded in a 50 mm diameter background medium can be quantitatively recovered. Small targets with various optical contrast levels relative to the background can be detected well. Embodiments of the subject reconstruction method can include first obtaining the map of absorbed optical energy density. Embodiments can obtain the map of absorbed optical energy density through a model-based reconstruction algorithm that is based on a finite element solution to the photoacoustic wave equation in frequency domain subject to the radiation or absorbing boundary conditions (BCs). The distribution of optical fluence can then be obtained. Embodiments can obtain the distribution of optical fluence using the photon diffusion equation based optimization procedure. The distribution of optical absorption coefficient can then be recovered from the distribution of optical fluence and the absorbed energy density.

### CROSS-REFERENCE TO RELATED APPLICATION

The present application claims the benefit of U.S. Application Ser. No. 60/950,304, filed Jul. 17, 2007, which is hereby incorporated by reference herein in its entirety, including any figures, tables, or drawings.

The subject invention was made with government support under a research project supported by a grant from the National Institutes of Health (NIH), Contract No. R01 CA90533.

### BACKGROUND OF INVENTION

Biomedical photoacoustic tomography (PAT) is a potentially powerful imaging method for visualizing the internal structure of soft tissues with excellent spatial resolution and satisfactory imaging depth. While conventional PAT can image tissues with high spatial resolution, it provides only the distribution of absorbed optical energy density that is the product of both the intrinsic optical absorption coefficient and extrinsic optical fluence distribution, which is a spatially varying function even for a homogeneous medium. Thus, the imaging parameter of conventional PAT is clearly not an intrinsic property of tissue. It is well known, however, that it is the tissue absorption coefficient that directly correlates with tissue physiological/functional information. When multiple wavelengths are used, the tissue absorption spectra allow for the extraction of tissue functional/physiological parameters, which are critical for accurate diagnostic decision-making, including hemoglobin concentration, blood oxygenation and water content. PAT combines high optical contrast and high ultrasound resolution in a single modality. Various PAT reconstruction algorithms have been developed and applied to the detection of breast cancer, skin cancer, vascular diseases and brain tumors in small animals.

Several methods suggest that it is possible to recover a scaled or relative measure of the absorption coefficient or functional parameters when conventional PAT is combined with a light transport model. However, there are several limitations associated with these methods. First, in these methods, one must know the exact boundary reflection coefficients as well as the exact strength and distribution of an incident light source, which requires careful experimental calibration procedures. It is often difficult to obtain these initial parameters accurately. Second, the recovered results strongly depend on the accuracy of the distribution of absolute absorbed energy density from conventional PAT. Third, these methods are based on simple data fitting procedures which are highly sensitive to boundary noises. It is also very difficult for such methods to tackle the negative absorbed energy density values often resulting from conventional PAT.

Diffuse optical tomography (DOT) is another emerging biomedical imaging modality that can image both tissue function and structure. However, the spatial resolution of DOT is low. In addition, the functional parameters obtained from DOT are often not accurate because of the strong crosstalk errors contributed from the scattering property of tissue.

Some researchers have shown theoretically that it is possible to recover an optical absorption coefficient with a simple iterative procedure based on a light transport model. It was subsequently demonstrated experimentally that the optical absorption coefficient images of heterogeneous media can indeed be obtained using this iterative method. However, there are several limitations associated with this simple iteration method. For example, must know the strength of incident light in advance. Moreover, it requires careful calibrations with a non-scattering medium.

### BRIEF SUMMARY

Embodiments of the invention pertain to a method and apparatus for imaging a light absorption coefficient distribution. Embodiments of the subject method can be implemented without knowing the strength of incident light in advance and without requiring careful calibrations in the non-scattering medium. Embodiments of the method can combine conventional photoacoustic tomography (PAT) with diffusing light measurements coupled with an optimization procedure based on the photon diffusion equation. Images of absorbing targets as small as 0.5 mm in diameter embedded in a 50 mm diameter background medium can be quantitatively recovered. Small targets with various optical contrast levels relative to the background can be detected well.

Embodiments can be utilized to image human, or animal, tissue. Specific embodiments involve imaging of a breast, the brain, a joint, and endoscopic imaging of the GI tract, colon, or esophagus.

Embodiments of the subject reconstruction method can include first obtaining the map of absorbed optical energy density. Embodiments can obtain the map of absorbed optical energy density through a model-based reconstruction algorithm that is based on a finite element solution to the photoacoustic wave equation in frequency domain subject to the radiation or absorbing boundary conditions (BCs). The distribution of optical fluence can then be obtained. Embodiments can obtain the distribution of optical fluence using the photon diffusion equation based optimization procedure. The distribution of optical absorption coefficient can then be recovered from the distribution of optical fluence and the absorbed energy density.

Embodiments of the invention allow the use of PAT for quantitative results, such as obtaining quantitative tissue functional information including oxy-hemoglobin, deoxy-hemoglobin and water and lipid concentrations, for example, which are crucial for accurate diagnostic decision-making. By combining PAT with DOT in accordance with an embodiment of the invention, the spatial resolution of DOT is significantly improved. In a specific embodiment combining PAT with DOT, the spatial resolution of DOT is improved from 5 mm to 1 mm given a large tissue volume. In addition, the hybrid modality can essentially eliminate the crosstalk errors existing in the current DOT techniques.

Embodiments of the invention can be applied to applications including, but not limited to, breast cancer detection/diagnosis, functional brain imaging, and joint imaging. Embodiments of the invention relate to a medical imaging device/system including both software and hardware, such that considerably higher spatial resolution for tissue functional imaging can be obtained, and much improved accuracy for drastically improved diagnostic decision-making can be achieved.

### BRIEF DESCRIPTION OF DRAWINGS

FIG. 1 shows a schematic of an embodiment of a photoacoustic imaging system, which can be utilized in accordance with the subject invention.

FIGS. 2A-2C show reconstructed optical absorption coefficient images (units; mm⁻¹), where FIG. 2A shows a 1 mm-diameter target, FIG. 2B shows two targets (2 and 3 mm in diameter, respectively), and FIG. 2C shows a 0.5 mm-diameter target.

FIG. 3 shows the recovered optical absorption profiles from the images shown in FIGS. 2A-2C, plotted along y=1 mm, plotted along y=−7 mm (3 mm-diameter target) and y=8 mm (2 mm-diameter target), and plotted along y=1 mm, respectively.

FIGS. 4A-4B show reconstructed optical absorption coefficient images (units; mm⁻¹) relative to the background, where FIG. 4A shows a 2 mm-diameter target having an optical contrast of 2:1, and FIG. 4B shows a 2 mm-diameter target having an optical contrast of 1.5:1.

FIG. 5 shows recovered optical absorption profiles from the images shown in FIGS. 4A and 4B, plotted along y=6 mm and plotted along y=6.5 mm, respectively.

FIGS. 6A-6D show reconstructed absorption coefficient images (FIGS. 6A and 6B) and absorbed optical energy density images (FIGS. 6C and 6D) for tests 1 and 2, where FIGS. 6A and 6C are for test 1, and FIGS. 6B and 6D are for test 2, where the axes (left and bottom) illustrate the spatial scale, in millimeters, and the gray scale (right) records the optical absorption coefficient in mm⁻¹, or absorbed optical energy density, in relative units.

FIGS. 7A-7B show reconstructed optical absorption coefficient images for test 3 (FIG. 7A) and test 4 (FIG. 7B), where the axes (left and bottom) illustrate the spatial scale, in millimeters, and the gray scale (right) records the optical absorption coefficient in mm⁻¹.

FIG. 8A shows a simulation test geometry with the exact distribution of absorbed energy density, where the axes (left and bottom) illustrate the spatial scale, in mm, and the gray scale (right) records the absorption coefficient in mm⁻¹, or absorbed optical energy density, in relative units.

FIG. 8B shows a reconstructed absorbed energy density image using photoacoustic tomography (PAT), where the axes (left and bottom) illustrate the spatial scale, in mm, and the gray scale (right) records the absorption coefficient in mm⁻¹, or absorbed optical energy density, in relative units.

FIG. 8C shows a recovered absorption coefficient image, where the axes (left and bottom) illustrate the spatial scale, in mm, and the gray scale (right) records the absorption coefficient in mm⁻¹, or absorbed optical energy density, in relative units.

The figures may not be drawn to scale. Moreover, where directional terms (such as above, over, left, right, under, below, etc.) are used with respect to the illustrations or in the discussion, they are used for ease of comprehension only and not as limitations. The elements of the devices may be oriented otherwise, as readily appreciated by those skilled in the art.

### DETAILED DISCLOSURE

Embodiments of the disclosure pertain to a method and apparatus for imaging a light absorption coefficient distribution. Embodiments of the subject method can be implemented without knowing the strength of incident light in advance and without requiring careful calibrations in the non-scattering medium. Embodiments of the method can combine conventional photoacoustic tomography (PAT) with diffusing light measurements coupled with an optimization procedure based on the photon diffusion equation. Images of absorbing targets as small as 0.5 mm in diameter embedded in a 50 mm diameter background medium can be quantitatively recovered. Small targets with various optical contrast levels relative to the background can be detected well.

Embodiments can be utilized to image human, or animal, tissue. Specific embodiments involve imaging of a breast, the brain, a joint, and endoscopic imaging of the GI tract, colon, or esophagus.

Embodiments of the subject reconstruction method can include first obtaining the map of absorbed optical energy density. Embodiments can obtain the map of absorbed optical energy density through a model-based reconstruction algorithm that is based on finite element solution to the photoacoustic wave equation in frequency domain subject to the radiation or absorbing boundary conditions (BCs). The distribution of optical fluence can then be obtained. Embodiments can obtain the distribution of optical fluence using the photon diffusion equation based optimization procedure. The distribution of optical absorption coefficient can then be recovered from the distribution of optical fluence and the absorbed energy density.

A reconstruction method that can be used for obtaining the map of absorbed optical energy density, allows for quantitative recovery of optical absorption coefficient maps of heterogeneous media using tomographic photoacoustic measurements. Images of the distribution of optical absorption coefficient are obtained from a diffusion equation based regularized. Newton method where the absorbed energy density distribution from conventional photoacoustic tomography serves as the measured field data. This method is experimentally demonstrated using tissue-mimicking phantom measurements where small objects were embedded in a 50 mm diameter background medium. The reconstruction results show that the optical absorption coefficient images obtained are quantitative in terms of the shape, size, location and optical property values of the heterogeneities examined.

Embodiments can apply the diffusion equation based iterative nonlinear algorithms that couple the conventional. Tikhonov regularization with a priori structural information-based regularization schemes for reconstruction of absorption coefficient using tomographic photoacoustic measurements. This method is demonstrated using a series of simulation and phantom experiments.

In an embodiment of the reconstruction method, the absorbed optical energy density is first recovered by a finite element-based PAT reconstruction algorithm. Other techniques can also be used. By incorporating the recovered absorbed energy density distribution into the photon diffusion equation, the absorption coefficient map is then extracted using a diffusion equation based regularized Newton method. The core procedure of an embodiment of the PAT algorithm can be described by the following two equations

$$\begin{matrix}{∇}^{2} p ( r , ω ) + {k}_{0}^{2} p ( r , ω ) = i {k}_{0} \frac{{c}_{0} β Φ ( r )}{{C}_{p}} & ( 1 ) \\ ( {𝒥}^{T} 𝒥 + λ I ) Δχ = {𝒥}^{T} ( {p}^{o} - {p}^{c} ) & ( 2 )\end{matrix}$$

in which p is the pressure wave; k₀=ω/c₀ is the wave number described by the angular frequency, ω and the speed of acoustic wave in the medium, c₀; β is the thermal expansion coefficient; Cₚ is the specific heat; Φ is absorbed optical energy density that is the product of optical absorption coefficient, μₐ and optical fluence or photon density, Ψ (i.e., Φ=μₐω); p^{o}=(p₁^{o}, p₂^{o}, . . . , p_{M}^{o})^{T}, p^{c}=(p₁^{c}, p₂^{c}, . . . , p_{M}^{c})^{T}, where pᵢ^{o} and pᵢ^{c} are observed and computed complex acoustic field data for i=1, 2 . . . , M boundary locations; Δ_{X} is the update vector for the absorbed optical energy density; ℑ is the Jacobian matrix formed by ∂p/∂Φ at the boundary measurement sites; λ is a Levenberg-Marquardt regularization parameter and I is the identity matrix. Thus, here the image formation task is to update absorbed energy density distribution via iterative solution of Eqs. (1) and (2) so that a weighted sum of the squared difference between computed and measured acoustic data can be minimized.

To recover the absorption coefficient from the absorbed energy density, Φ, the photon diffusion equation as well as the Robin boundary conditions can be written in consideration of Φ=μₐΨ,

∇·D(r)∇(E(r)Φ(r))−Φ(r)=−S(r) (3)

−D∇(E(r)Φ)·n=E(r)αΦ (4)

where E(r)=1/μₐ (r), D(r) is the diffusion coefficient, D=1/(3(μₐ+μ′ₛ)) and μ′ₛ is the reduced scattering coefficients, α is a boundary condition coefficient related to the internal reflection at the boundary, and S(r) is the incident point or distributed source term. For the inverse computation, the so-called Tikhonov-regularization sets up a weighted term as well as a penalty term in order to minimize the squared differences between computed and measured absorbed energy density values,

$${min}_{χ} \{ {‖ {F}^{c} - {F}^{o} ‖}^{2} + β {‖ L [ E - {E}_{0} ] ‖}^{2} \qquad ( 5 )$$

where L is the regularization matrix or filter matrix, β is the regularization parameter. F^{o}=(Φ₁^{o}, Φ₂^{o}, . . . , Φ_{N}^{o})^{T} and F^{c}=(Φ₁^{c}, Φ₂^{c}, . . . Φ_{N}^{c})^{T}, where Fᵢ^{o} is the absorbed energy density obtained from PAT, and Fᵢ^{c} is the absorbed energy density computed from Eqs. (3) and (4) for i=1, 2 . . . , N locations within the entire PAT reconstruction domain. The initial estimate of absorption coefficient can be updated based on iterative Newton method as follows,

(εE)=(J^{T}J+λI+βL^{T}L)⁻¹[J^{T}(F^{o}−F^{c})−βL^{T}LE] (6)

where J is the Jacobian matrix formed by ∂Φ/∂E inside the whole reconstruction domain including the boundary zone. In this disclosure, the practical update equation resulting from Eq. (6) is utilized with β=1,

Δ(E)=(J^{T}J+λI+L^{T}L)⁻¹[J^{T}(F^{o}−F^{c})] (7)

In addition to the usual Tikhonov regularization, the PAT image (absorbed energy density map) is used both as input data and as prior structural information to regularize the solution so that the ill-posedness associated with such inversion can be reduced. In an embodiment of a reconstruction scheme, the PAT image is segmented into different regions according to different heterogeneities or tissue types using commercial software. The distribution of absorbed energy density in the entire imaging domain and segmented prior structural information for optical inversion are then both employed. The segmented prior spatial information can be incorporated into the iterative process using the regularization filter matrix, L shown in Eq. (7). Laplacian-type filter matrix is employed and constructed according to the region or tissue type it is associated based on derived priors. This filter matrix is able to relax the smoothness constraints at the interface between different regions or tissues, in directions normal to their common boundary so that the co-variance of nodes within a region is basically realized. As such, the elements of matrix L, Lᵢⱼ, is specified as follows:

$${L}_{ij} = \{ \begin{matrix}1 & if i = j \\ - 1 / NN & if i , j ⋐ one region \\ 0 & if i , j ⋐ diffrent region\end{matrix} \qquad ( 8 )$$

where NN is the total node number within one region or tissue.

Thus, the optical absorption coefficient distribution is reconstructed through the iterative procedures described by Eqs. (3) and (7). It is noted from Eq. (7) that a hybrid regularization scheme that combines both Levenberg-Marquardt and Tikhonov regularizations has been used. Additionally, when λ=(F^{o}−F^{c})×trace[J^{T}J], the reconstruction algorithm generates best results for PAT guided optical reconstruction and the boundary noise is also reduced significantly.

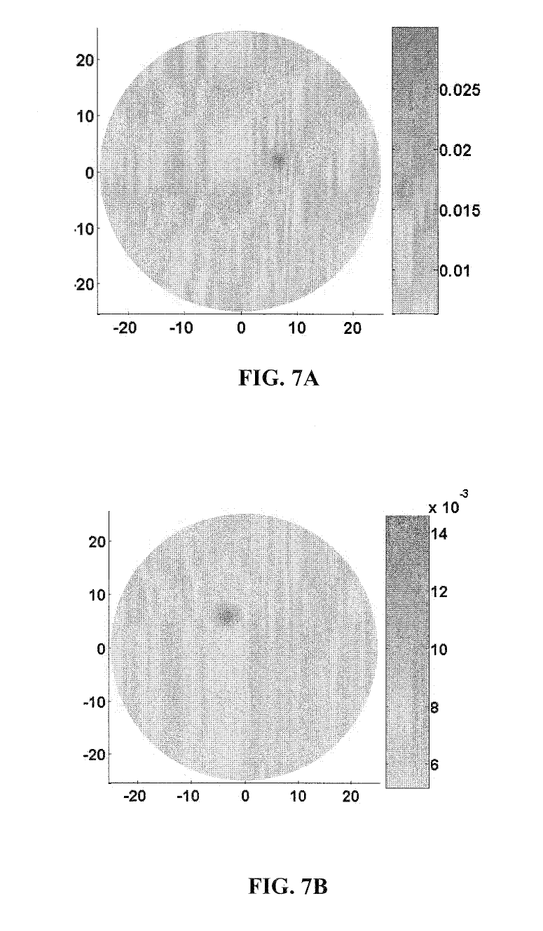

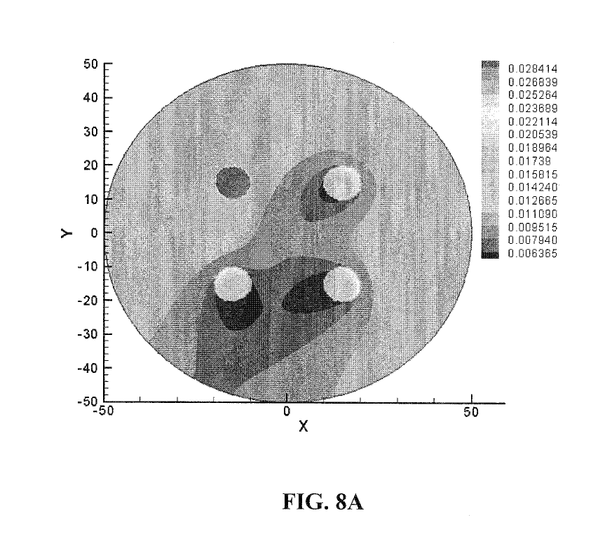

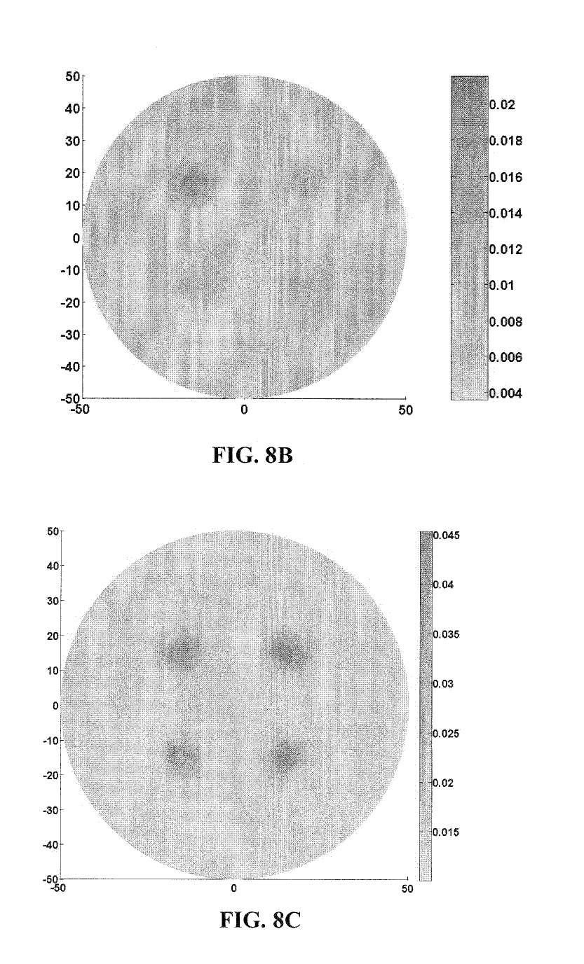

The image formation process described above is tested first using simulated data. The test geometry is shown in FIG. 8A, where a circular background region (50 mm in radius) contained four circular targets (5 mm in radius each). The optical properties for the targets were μₐ=0.04 mm⁻¹ and μ′ₛ=1.0 mm⁻¹ while optical properties for the background were μₐ=0.01 mm⁻¹ and μ′ₛ=1.0 mm⁻¹. 16 point sources were distributed uniformly around the boundary of background region and the exact absorbed energy density distribution (μₐΨ) was plotted in FIG. 8A. A total of 120 receivers that were equally distributed along the boundary of background region and 50 frequencies were used for reconstruction computation.

In another embodiment, the photon diffusion equation based optimization is coupled with the map of absorbed optical energy density. The photon diffusion equation based optimization is based on the iterative solution of the following diffusion equation and X² calculation:

$$\begin{matrix}∇ \cdot D ∇ Ψ ( r ) - {μ}_{a} Ψ ( r ) = - S ( r ) & ( 9 ) \\ {χ}^{2} = {\sum }_{i = 1}^{M} {( {Ψ}_{i}^{( m )} - {Ψ}_{i}^{( c )} )}^{2} & ( 10 )\end{matrix}$$

where D is the diffusion coefficient and can be written as D=1/(3(μₐ+μ′ₛ)) where μ′ₛ is the reduced scattering coefficient; S is the excitation source; Ψᵢ^{(m)} and Ψᵢ^{(c)} are the measured and calculated optical fluence for i=1, 2, . . . M boundary locations. The distribution of optical fluence is obtained within the entire imaging domain through an optimization procedure based on Eqs. (9) and (10). This simple least-squares minimization scheme can be explained as follows. Given a range of values of μ′ₛ, μₐ, and S (always available empirically), the X² error as function of μ′ₛ, μₐ, and S is computed, where Ψᵢ^{(m)} is from the measured optical data and Ψᵢ^{(c)} is calculated from Eq. (9). The rationale of this scheme is based on the argument that the minimum of X² corresponds to the effective values of μ′ₛ, μₐ, and S associated with the medium of interest. The desired distribution of optical fluence, Ψ, is calculated from Eq. (9) with the optimized set of μ′ₛ, μₐ, and S in place. Thus, the final distribution of μₐ is calculated using μₐ=Φ/Ψ where Φ is obtained from the conventional PAT. This division is computationally stable, because there is little to no possibility of having a zero or close to zero value for Ψ.

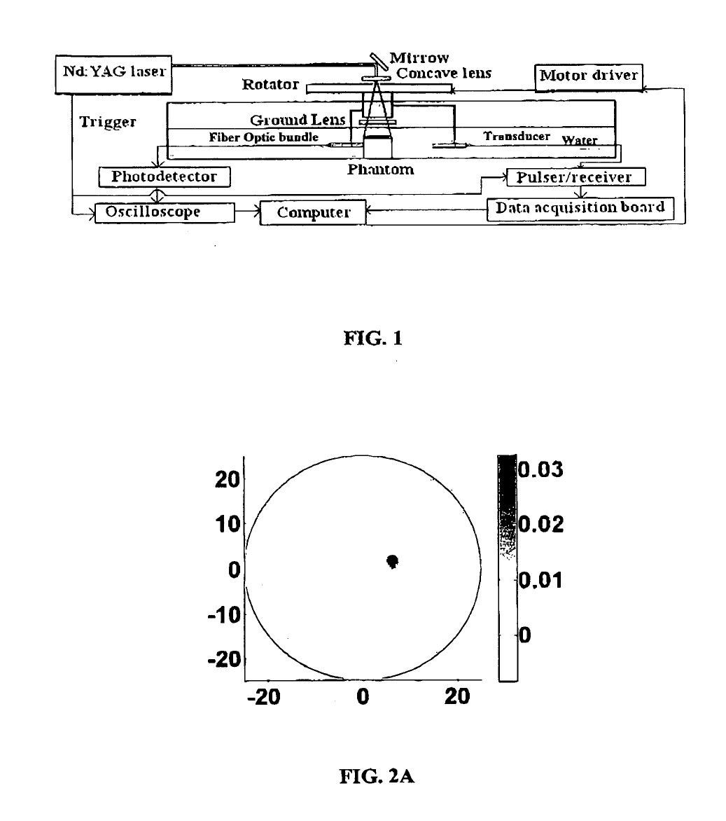

An embodiment of a PAT imaging system is shown in FIG. 1. Pulsed light from a Nd: YAG laser (wavelength: 532 nm, pulse duration: 3-6 ns) is coupled into a phantom via an optical subsystem and acoustic signals are generated. The transducer and phantom are immersed in a water tank. The water tank allows the use of a single transducer, where an array of transducers can be used if the transducer and phantom are not immersed in the water tank. A rotary stage rotates the receiver relative to the center of the tank. A 1 MHz transducer is used to receive the acoustic signals, providing a spatial resolution of about 1 mm The incident fluence is controlled below 10 mJ/cm² and the incident laser beam diameter is 5 cm. In the first three experiments described herein, one or two objects with a size ranging from 3 to 0.5 mm were embedded in a 50 mm-diameter solid cylindrical phantom. The phantom materials used Intralipid as scatterer and India ink as absorber with Agar powder (1-2%) for solidifying the Intralipid and India ink solution. The object-bearing solid phantom was then immersed into the water tank. The absorption coefficient of the background phantom was 0.01 mm⁻¹, while the absorption coefficient of the target(s) was 0.03 mm⁻¹ In the final two experiments described herein, a single-target-containing phantom was placed into the water, aiming to test the capability of detecting target having different optical contrasts relative to the background phantom. In these two cases, the targets had an absorption coefficient of 0.02 and 0.015 mm⁻¹, respectively. The reduced scattering coefficients of the background phantom and targets being used in the phantom were 1.0 and 3.0 mm⁻¹ for the first two experiments, and 1.0 and 2.0 mm⁻¹ for the final two experiments.

Diffusing light was collected along the surface of the phantom using a 2 mm diameter fiber optic bundle coupled with a 2 GHz bandwidth high speed photodetector and recorded by a 2.5 GHz bandwidth digital oscilloscope. A computer controlled the scanning of the fiber bundle and 120 optical measurements were conducted and used in the calculation.

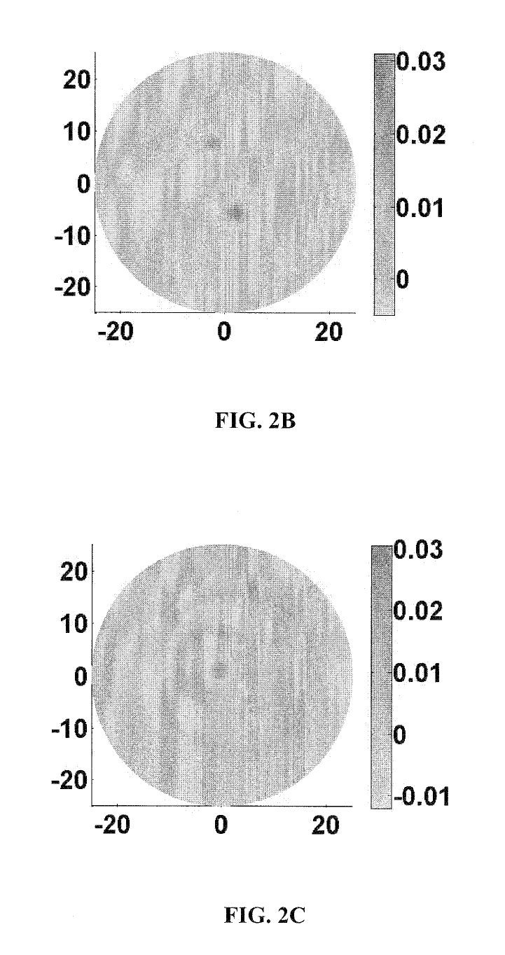

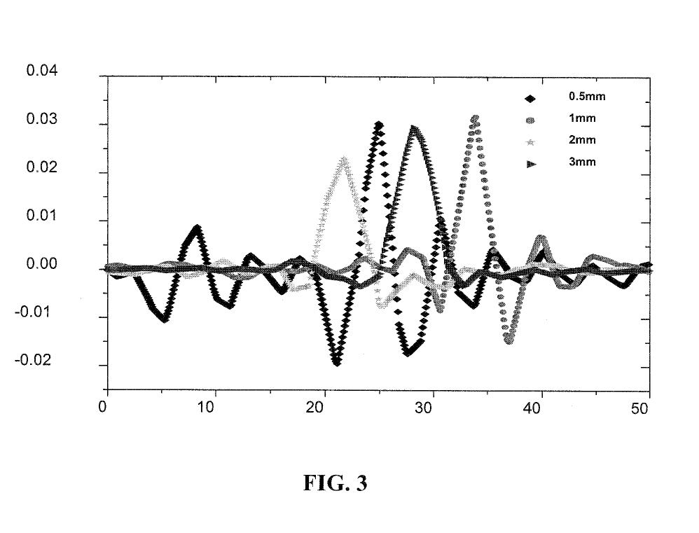

FIGS. 2A-2C present the reconstructed optical absorption images of one or two objects having a size of 1.0 mm (FIG. 2A), 2.0 and 3.0 mm (FIG. 2B), and 0.5 mm (FIG. 2C) in diameter. The object(s) in each case are clearly detected. By estimating the full width half maximum (FWHM) of the envelop of the optical absorption property profiles shown in FIG. 3, the recovered object sizes were found to be 1.1, 1.7, 3.2, and 0.7 mm, which is in good agreement with the actual object size of 1.0, 2.0, 3.0, and 0.5 mm. Also, from FIG. 3, the reconstructed images are quantitative in terms of the recovered absorption coefficient value of the objects.

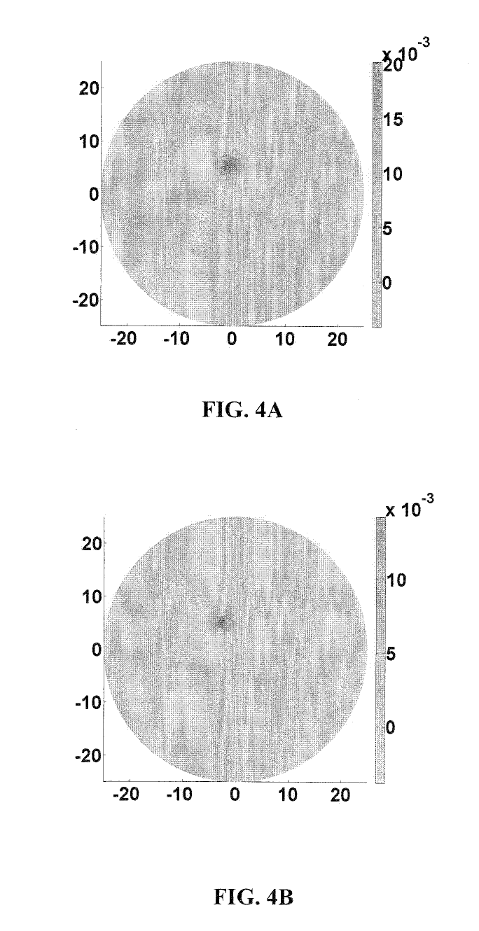

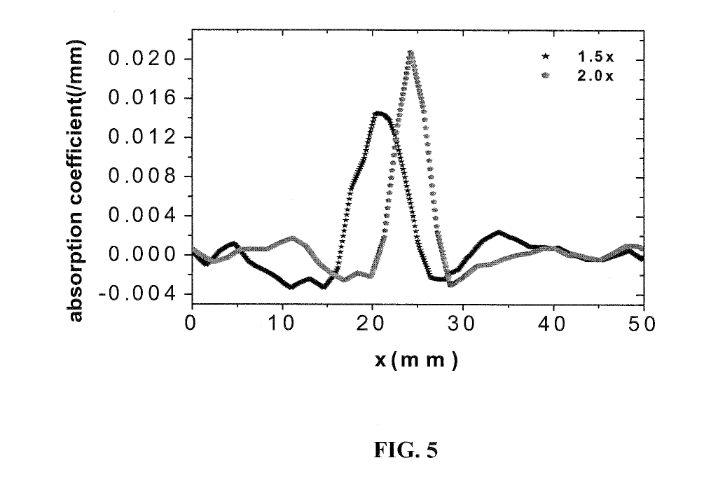

The reconstructed absorption coefficient images of the final two cases are shown in FIGS. 4A and 4B, and the associated absorption coefficient profiles are depicted in FIG. 5. The different optical contrast levels of the objects relative to the background are clearly resolvable.

The imaging quality for the smallest target (FIG. 2C) and lowest contrast (FIG. 4B) cases is degraded with stronger artifacts and over- or under-estimated target size, compared to that for the larger target and higher contrast cases. The degradation is most likely due to the lower signal-to-noise ratio (SNR) for the smallest target and lowest contrast cases. The nonunifoimity, significant variation, and negative values seen in FIGS. 2 and 4 are likely primarily caused by the limited bandwidth of the transducer used which is directly related to the target size. This is evident from FIG. 3, where a clear trend is seen: the smaller the target size, the larger the amplitude of the negative values. For example, the peak negative value for the 0.5, 1.0, 2.0, and 3.0 mm target is −0.02, −0.015, −0.007, and 0.003 mm⁻¹, respectively. In addition, the negative value issue does not appear to be related to the contrast level. For example, the image of the 2 mm target size with 3:1 contrast gives almost the same level of amplitude of negative value as the images of the 2 mm target size with 2:1 or 1.5:1 contrast (FIG. 5).

The assumption of homogeneous or constant absorption coefficient during the procedure for estimating the distribution of optical fluence should not contribute to the degradation significantly, because the heterogeneity size is small in the cases studied here. This assumption may have significant impact on the estimation of the distribution of optical fluence if the heterogeneity size becomes large (e.g., larger than 1 cm in diameter). In this case, diffuse optical tomography (DOT) can be used and/or PAT methods without such an assumption for reconstructing the distribution of absorption coefficient can be used. Embodiments of the invention allow the acquisition of absolute optical absorption coefficient images of targets as small as 0.5 mm in diameter using photoacoustic imaging methods. This high-resolution ability for imaging small absorbing targets is not possible for DOT, a pure optical method for imaging of large tissues.

In other experiments, the incident fluence was controlled below 10 mJ/cm² and the incident laser beam diameter was 5.0 cm. For the first two experiments, we embedded two objects with a size ranging from 2.0-5.5 mm in diameter in a 50 mm-diameter solid cylindrical phantom. We then immersed the object-bearing solid phantom into a 110.6 mm-diameter water background. The phantom materials used included Intralipid as scatterer and India ink as absorber with Agar powder (1-2%) for solidifying the Intralipid and India ink solution. The background phantom had μₐ=0.01 mm⁻¹ and μ′ₛ=1.0 mm⁻¹ while the two targets had μₐ=0.03 mm⁻¹ and μ′ₛ=2.0 mm⁻¹ for test 1, and μₐ=0.07 mm⁻¹ and μ′ₛ=3.0 mm⁻¹ for test 2. In the next two experiments, a single-target-containing phantom was placed into the water, aiming to test the capability of resolving target having different optical contrasts relative to the background phantom. The target size was 1.0 and 20 mm in diameter for tests 3 and 4, respectively. The target had μₐ=0.03 mm⁻¹ and μ′ₛ=2.0 mm⁻¹ for test 3, and μₐ=0.015 mm⁻¹ and μ′ₛ=2 mm⁻¹ for test 4. In the image reconstructions for these four tests, a scattering coefficient was assumed as constant (1.0 mm⁻¹). The initial guesses of optical absorption coefficient for the target(s) and background medium were 0.02 mm⁻¹ and 0.01 mm¹, respectively, based on the absorbed energy density distribution within the possible range of absorption coefficient value, e.g., the higher the absorbed energy density within a region, the higher the initial absorption coefficient in this region and vice versa. 50 frequencies were used for PAT reconstruction, which took about 30 minutes with about 20 iterations to complete the two-step inverse computation for each case. The pulsed laser wavelength utilized was 532 nm for the four experiments described above.

FIG. 8A shows simulation test geometry with the exact distribution of absorbed energy density; FIG. 8B shows reconstructed absorbed energy density image using PAT; and FIG. 8C shows recovered absorption coefficient image. The axes (left and bottom) illustrate the spatial scale, in mm, and the gray scale (right) records the absorption coefficient in mm⁻¹, or absorbed optical energy density, in relative units.

The results from simulated data are shown in FIGS. 8B and 8C where FIG. 8B presents the reconstructed absorbed optical energy density using the existing PAT algorithm, while FIG. 8C displays the recovered optical absorption coefficient image with the regularized Newton method. It is observed from FIGS. 8A and 8B that the influence of the inhomogeneous incident light on the PAT reconstruction is apparent: the four targets having the same absorption coefficient show clear uneven distribution of absorbed energy density due to the inhomogeneous distribution of photon density. Thus, in this case, conventional PAT cannot provide correct image of tissue optical properties. FIG. 8C demonstrates that the embodiment of the subject invention applied is able to provide quantitatively accurate image of tissue optical properties.

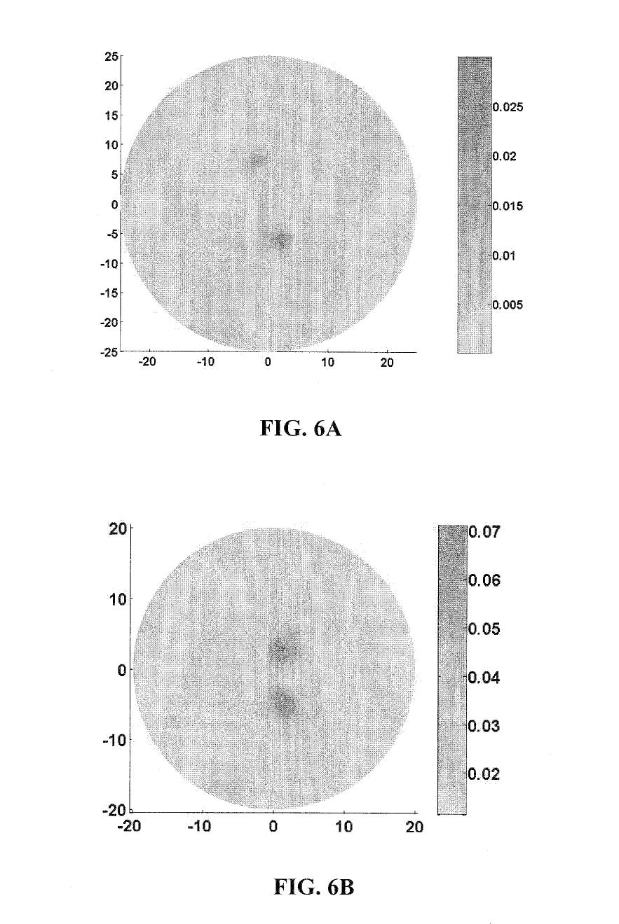

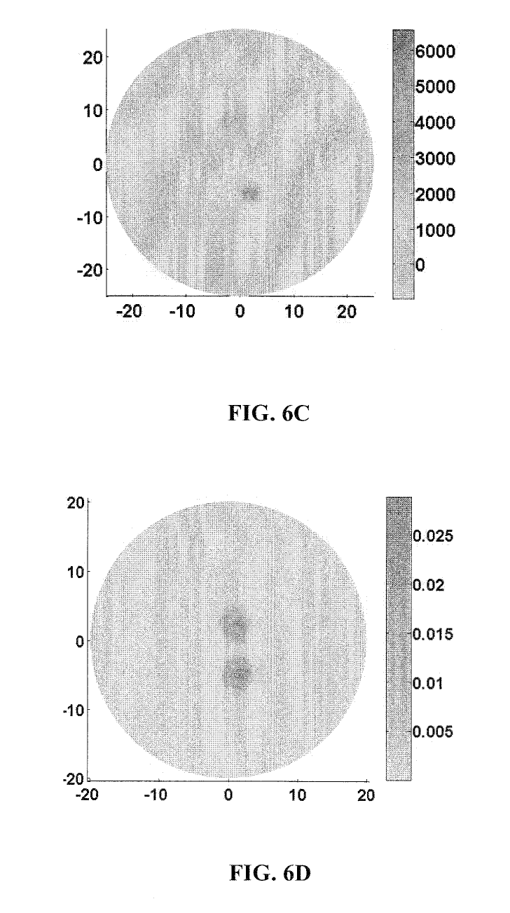

The results from the first two sets of experiments are shown in FIGS. 6A and 6B where FIGS. 6A and 6B present the reconstructed absorption coefficient images of two objects having a size of 2.0 and 3.0 mm (test 1), and 5.5 mm (test 2) in diameter, respectively, while the recovered absorbed energy density maps for tests 1 and 2 are also plotted in FIGS. 6C and 6D for comparison. The objects in each case are clearly detected. As shown in Table 1, the recovered absorption coefficients of the target and background are quantitative compared to the exact values for both tests. By estimating the full width half maximum (FWHM) of the absorption coefficient profiles, the recovered object sizes were found to be 1.8, 2.7, and 5.0 mm, which are in good agreement with the actual object sizes of 2.0, 3.0, and 5.5 mm for tests 1 and 2. The reconstructed absorption coefficient images for tests 3 and 4 are shown in FIGS. 7A and 7B. The different optical contrast levels of the objects relative to the background are quantitatively resolved.

TABLE 1
Average value of the recovered optical absorption coefficient
(mm⁻¹) of target and background and target size (mm) for tests 1 and 2

| | | | Targets (μₐ) | | Background (μₐ) | | Target sizes | |
|---|---|---|---|---|---|---|---|---|
| | | Test | Reconstructed | Exact | Reconstructed | Exact | Reconstructed | Exact |
| | | Target 1 | 0.027 | 0.03 | 0.012 | 0.01 | 1.8 | 2.0 |
| (1) | {open oversize brace} | | | | | | | |
| | | Target 2 | 0.028 | 0.03 | 0.012 | 0.01 | 2.7 | 3.0 |
| (2) | | Target 1: | 0.067 | 0.07 | 0.011 | 0.01 | 5.0 | 5.5 |

It is interesting to note that specific embodiments of the subject reconstruction method do not need any calibration procedure due to the use of relative incident laser source strength and normalized absorbed energy density distribution. The absorbed energy density is first normalized via their maximum value. An optimization scheme was then applied to search for the boundary conditions coefficient, α and the relative source strength as described previously. As such, the reconstruction of optical properties does not depend on the absolute values of absorbed energy density and optical fluence as well as the boundary parameter. For example, even though the values/scales of the absorbed energy density for tests 1 and 2 are very different as shown in FIGS. 6C and 6D, the technique is still able to recover the absorption coefficient images quantitatively in terms of the location, size, and absorption coefficient value of the objects. In addition, embodiments of the subject method are able to resolve the issue of negative absorbed energy density values often seen in conventional PAT.

Embodiments of the subject method are robust for recovering absorption coefficient images when the incident light is relatively homogeneous (e.g., the large diameter beam irradiated the phantom from the top surface as used in the experiments presented), which generates an absorbed energy density distribution that is similar to that of absorption coefficient. However, if the incident light is inhomogeneous (e.g., a point source is used or the phantom is irradiated from the cylindrical surface of the phantom), the distribution of absorbed energy density will be quite different from the distribution of absorption coefficient.

Experimental results show that it is possible to obtain an absolute optical absorption coefficient image using photoacoustic tomography coupled with diffusion equation based regularized Newton method. The methods described are able to quantitatively reconstruct absorbing objects with different sizes and optical contrast levels.

Embodiments of the subject invention can be used to image human, or animal, tissue. Specific embodiments involve imaging of a breast, the brain, a joint, and endoscopic imaging of the GI tract, colon, or esophagus. In a specific embodiment, a pulsed laser beam is sent into the body to be imaged. An ultrasound signal is then generated in the body by the pulsed laser beam and the ultrasound signal is collected to obtain an absorbed optical energy density map. A distribution of optical fluence can be obtained and then an optical absorption coefficient image can be produced. The optical absorption coefficient image can then allow for tumor detection, functional brain imaging and diagnosis of arthritis as diseased and normal tissues have significantly different tissue absorption coefficient distributions.

In a specific embodiment, the distribution of optical fluence can be obtained with a optical fiber bundle collecting diffusing light from the sample being imaged. In further embodiments, the distribution of optical fluence is obtained via other techniques, such as a photon diffusion equation based optimization procedure. In a specific embodiment, the wavelength of the light can be near IR, for example, 600 nm-950 nm. If the wavelength of the light is changed, functional parameters can be obtained by getting absorption spectra.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A method for imaging, comprising:
obtaining a map of absorbed optical energy density;
obtaining a distribution of optical fluence; and
obtaining a distribution of optical absorption coefficient image using the map of absorbed optical energy density and the distribution of optical fluence.

2. The method according to claim 1, wherein obtaining a map of absorbed optical energy density comprises obtaining a map of absorbed optical energy density through a model-based reconstruction algorithm that is based on a finite element solution to a photoacoustic wave equation.

3. The method according to claim 2, wherein obtaining a map of absorbed optical energy density through a model-based reconstruction algorithm that is based on a finite element solution to a photoacoustic wave equation comprises obtaining a map of absorbed optical energy density through a model-based reconstruction algorithm that is based on a finite element solution to a photoacoustic wave equation in the frequency domain subject to the radiation or absorbing boundary conditions.

4. The method according to claim 1, wherein obtaining a distribution of optical fluence comprises obtaining a distribution of optical fluence using a photon diffusion equation based optimization procedure.

5. The method according to claim 1, wherein obtaining the map of absorbed optical energy density comprises using a regularized Newton method.

6. The method according to claim 5, wherein obtaining a distribution of optical fluence comprises obtaining a distribution of optical fluence using a photon diffusion equation based optimization procedure.

7. The method according to claim 5, further comprising producing an optical absorption coefficient image.

8. The method according to claim 1, wherein obtaining the map of absorbed optical energy density comprises iteratively solving a first equation
$${∇}^{2} p ( r , ω ) + {k}_{0}^{2} p ( r , ω ) = i {k}_{0} \frac{{c}_{0} β Φ ( r )}{{C}_{p}}$$
and a second equation
(ℑ^{T}ℑ+λI)Δ_{X}=ℑ^{T}(p^{o}−p^{c})
in which p is a pressure wave; k₀=ω/c₀ is a wave number described by an angular frequency, ω0 and a speed of acoustic wave in a medium, c₀; β is a thermal expansion coefficient; Cₚ is a specific heat; Φ is an absorbed optical energy density that is a product of an optical absorption coefficient, μₐ and optical fluence or photon density, Ψ (i.e., Φ=μₐΨ); p^{o}=(p₁^{o}, p₂^{o}, . . . , p_{M}^{o})^{T}, p^{c}=(p₁^{c}, p₂^{c}, . . . , p_{M}^{c})^{T}, where pᵢ^{o} and pᵢ^{c} are observed and computed complex acoustic field data for i=1, 2 . . . , M boundary locations; Δ_{X} is an update vector for the absorbed optical energy density; ℑ is a Jacobian matrix formed by ∂p/∂Φ at boundary measurement sites; λ is a Levenberg-Marquardt regularization parameter; and I is an identity matrix.

9. The method according to claim 8, wherein obtaining the map of absorbed optical energy density, Φᵢ^{c}, for i=1, 2 . . . , N locations within a photoacoustic tomography reconstruction domain comprises solving
a third equation
∇·D(r)∇(E(r)Φ(r))−Φ(r)=−S(r)
and a fourth equation
−D∇(E(r)Φ)·n=E(r)αΦ
where Φ=μₐΨ, E(r)=1/μₐ(r), D(r) is a diffusion coefficient, D=1/(3(μₐ+μ′ₛ)) and μ′ₛ is a reduced scattering coefficients, α is a boundary condition coefficient related to internal reflection at a boundary, and S (r) is an incident point or distributed source term.

10. The method according to claim 8, wherein obtaining a distribution of optical fluence comprises iteratively solving
a third equation
∇·D∇Ψ(r)−μₐΨ(r)=−S(r)
and a fourth equation
$${χ}^{2} = {\sum }_{i = 1}^{M} {( {Ψ}_{i}^{( m )} - {Ψ}_{i}^{( c )} )}^{2}$$
where D is a diffusion coefficient and can be written as D=1/(3(μₐ+μ′ₛ)) where μ′ₛ is a reduced scattering coefficient; S is an excitation source; Ψᵢ^{(m)} and Ψᵢ^{(c)} are measured and calculated optical fluence for i=1, 2, . . . M boundary locations.

11. The method according to claim 7, wherein obtaining a distribution of optical absorption coefficient images comprises calculating μₐ=Φ/Ψ.

12. A method for biomedical imaging, comprising:
obtaining a map of absorbed optical energy density; and
obtaining a distribution of optical absorption coefficient image using the absorbed optical energy density and optical fluence.

13. The method according to claim 12, wherein obtaining a map of absorbed optical energy density comprises obtaining a map of absorbed optical energy density through a model-based reconstruction algorithm that is based on a finite element solution to a photoacoustic wave equation.

14. The method according to claim 13, wherein obtaining a map of absorbed optical energy density through a model-based reconstruction algorithm that is based on a finite element solution to a photoacoustic wave equation comprises obtaining a map of absorbed optical energy density through a model-based reconstruction algorithm that is based on a finite element solution to a photoacoustic wave equation in the frequency domain subject to the radiation or absorbing boundary conditions.

15. The method according to claim 12, further comprising obtaining a distribution of optical fluences wherein obtaining a distribution of optical fluence comprises obtaining a distribution of optical fluence using a photon diffusion equation based optimization procedure.

16. The method according to claim 12, wherein the step of obtaining the map of absorbed optical energy density comprises using a regularized Newton method.

17. The method according to claim 12, further comprising producing an optical absorption coefficient image.

18. The method according to claim 12, wherein the step of obtaining the map of absorbed optical energy density comprises iteratively solving
a first equation
$${∇}^{2} p ( r , ω ) + {k}_{0}^{2} p ( r , ω ) = i {k}_{0} \frac{{c}_{0} β Φ ( r )}{{C}_{p}}$$
and a second equation
(ℑ^{T}ℑ+λI)Δ_{X}=ℑ^{T}(p^{a}−p^{c})
in which p is a pressure wave; k₀=ω/c₀ is a wave number described by an angular frequency, ω and a speed of acoustic wave in a medium, c₀; β is a thermal expansion coefficient; Cₚ is a specific heat; Φ is an absorbed optical energy density that is a product of an optical absorption coefficient, μₐ and optical fluence or photon density, Ψ (i.e., Φ=μₐΨ); p^{o}=(p₁^{o}, p₂^{o}, . . . , p_{M}^{o})^{T}, p^{c}=(p₁^{c}, p₂^{c}, . . . , p_{M}^{c})^{T}, where pᵢ^{o} and pᵢ^{c} are observed and computed complex acoustic field data for i=1, 2 . . . , M boundary locations; Δ_{X} is an update vector for the absorbed optical energy density; ℑ is a Jacobian matrix formed by ∂p/∂Φ at boundary measurement sites; λ is a Levenberg-Marquardt regularization parameter; and I is an identity matrix.

19. The method according to claim 18, wherein obtaining the map of absorbed optical energy density, Φᵢ^{c}, for i=1, 2 . . . , N locations within a photoacoustic tomography reconstruction domain comprises solving
a third equation
∇·D(r)∇(E(r)Φ(r))−Φ(r)=−S(r)
and a fourth equation
−D∇(E(r)Φ)·n=E(r)αΦ
where Φ=μₐΨ, E(r)=1/μₐ(r), D(r) is a diffusion coefficient, D=1/(3(μₐ+μ′ₛ)) and μ′ₛ is a reduced scattering coefficients, α is a boundary condition coefficient related to internal reflection at a boundary, and S (r) is an incident point or distributed source term.

20. The method according to claim 19, wherein obtaining a distribution of optical absorption coefficient images comprises estimating an absorption coefficient based on an equation (δE)=(J^{T}J+λI+βL^{T}L)⁻¹[J^{T}(Φ^{o}−Φ^{c})−βL^{T}LE] where J is a Jacobian matrix formed by ∂Φ/∂E inside a whole reconstruction domain including a boundary zone and L is a Laplacian-type filter matrix such that elements of matrix L, Lᵢⱼ, is specified as follows:
$${L}_{ij} = \{ \begin{matrix}1 & if i = j \\ - 1 / NN & if i , j ⋐ one region \\ 0 & if i , j ⋐ diffrent region\end{matrix}$$
where NN is a total node number within one region or tissue being imaged.

21. The method according to claim 20, wherein obtaining a distribution of optical absorption coefficient images comprises a hybrid regularization scheme that combines Levenberg-Marquardt and Tikhonov regularizations.

22. The method according to claim 20, wherein λ=(Φ^{o}−Φ^{c})×trace[J^{T}J].
